(19) United States
(12) Patent Application Publication
(10) Pub. No.: US 2007/0136441 A1
(43) Pub. Date: Jun. 14, 2007

(54) Multimedia user interaction over IP network

(76) Inventors: Su-Yuan Chang, Hsinchu (TW); Yin-Ju Chen, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/296,454

(22) Filed: Dec. 8, 2005

(51) Int. Cl. G06F 15/16

(52) U.S. Cl. 709/219

(57) ABSTRACT

The present invention is to disclose a multimedia interactive system, which comprising a plurality of multimedia interactive clients, a multimedia interactive server, and a multimedia content server connected to an IP (Internet Protocol) network. Each of said multimedia interactive client further comprising a SIP (Session Initiation Protocol) user agent and a web browser. The multimedia interactive server comprising a SIP proxy server for servicing said SIP user agents of said plurality of multimedia interactive clients. And the multimedia content server provides multimedia content, designated in SIP communication by said multimedia interactive server, to said web browsers of said plurality of multimedia interactive clients.

### BACKGROUND OF THE INVENTION

1. Field of the Invention

The present invention generally relates to multimedia user interaction and more particularly to multimedia user interaction over IP (Internet Protocol) networks.

2. Description of the Prior Art

Now, IP (Internet Protocol) is one of the most popular communication protocols in the world. It is built upon a lot of physical media and underlying communication protocols, such as Ethernet, SDH (Synchronous Digital Hierarchy), WLAN (Wireless Local Area Network), GPRS (General Packet Radio Service), and etc. Also, some communication protocols specialized for some applications are built upon IP, for example, SIP (Session Initiation Protocol), TCP (Transmission Control Protocol), FTP (File Transport Protocol), HTTP (Hyper-Text Transmission Protocol), and etc.

In this regards, SIP, defined at RFC 2543, is an application layer control protocol for creating, modifying and terminating sessions with one or more participants. These sessions include Internet multimedia conferences, Internet telephone calls and multimedia distribution. Members in a session can communicate via multicast or via a mesh of unicast relations, or a combination of these. SIP invitations used to create sessions carry session descriptions which allow participants to agree on a set of compatible media types. SIP supports user mobility by proxying and redirecting requests to the user's current location. Users can register their current location. HTTP is also a well-known application control protocol for web browsing and simple client-server interactions. Furthermore, some protocols, for example, web services, are built upon HTTP for complicated client-server interactions by incorporating XML (Extensible Markup Language) technologies. Other proprietary communication protocols are configured to take advantage of IP for multimedia client-server interactions.

Recently, the third generation (3G) telecommunication networks gradually became a popular mobile environment around the world. The third generation telecommunication incorporates Internet Protocol (IP) over underlying protocols for providing General Packet Radio Service (GPRS). In this disclosure, the applicable 3G technologies, such as W-CDMA (Wideband Code Division Multiple Access) and CDMA2000, are taught from the 3GPP (Third Generation Project Partnership) and the 3GPP2 alliances. The 3G standards define multi-media sub-system architecture for providing multimedia services to user equipments. SIP is also embraced into 3G standards.

However, there are two different things independently for voice communication and multimedia user interactions in user equipments, for example, a smart phone, a PDA (Personal Digital Assistance) phone, or a featured phone up to day. In a smart phone, a web browser is provided to surfer the Internet and another voice application is provided to voice communication. Not only those two applications are working independently, but also the connected web servers and voice proxy/redirect servers. Hence, it is not possible to synchronize the multimedia presentation and voice conversation at both the client side and server side.

### SUMMARY OF THE INVENTION

Therefore, in accordance with the previous summary, objects, features and advantages of the present disclosure will become apparent to one skilled in the art from the subsequent description and the appended claims taken in conjunction with the accompanying drawings.

A object of the present invention is to disclose a multimedia interactive system, which comprising a plurality of multimedia interactive clients, a multimedia interactive server, and a multimedia content server connected to an IP (Internet Protocol) network. Each of said multimedia interactive client further comprising a SIP (Session Initiation Protocol) user agent and a web browser. The multimedia interactive server comprising a SIP proxy server for servicing said SIP user agents of said plurality of multimedia interactive clients. And the multimedia content server provides multimedia content, designated in SIP communication by said multimedia interactive server, to said web browsers of said plurality of multimedia interactive clients.

Another object of the present invention is to disclose a multimedia interactive method, which comprises providing a multimedia interactive system at first. The multimedia interactive system comprises a plurality of multimedia interactive clients, a multimedia interactive server, and a multimedia content server connected to an IP (Internet Protocol) network. Each of said multimedia interactive client further comprising a SIP (Session Initiation Protocol) user agent and a web browser. The multimedia interactive server comprising a SIP proxy server for servicing said SIP user agents of said plurality of multimedia interactive clients. And the method also comprises providing multimedia content, designated in SIP communication by said multimedia interactive server, to said web browsers of said plurality of multimedia interactive clients.

### BREIF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1A is a block diagram of a multimedia interactive system depicts an embodiment in accordance with the present invention;

FIG. 1B is a detailed diagram shows a multimedia interactive system of an embodiment in accordance with the present invention;

FIG. 2 is a detailed diagram shows a multimedia interactive system of an embodiment in accordance with the present invention;

FIG. 3 is a sequence diagram illustrates how the interactive server pushes contents to user equipments.

### DETAILED DESCRIPTION OF THE PREFERRED EMBODIMENTS

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

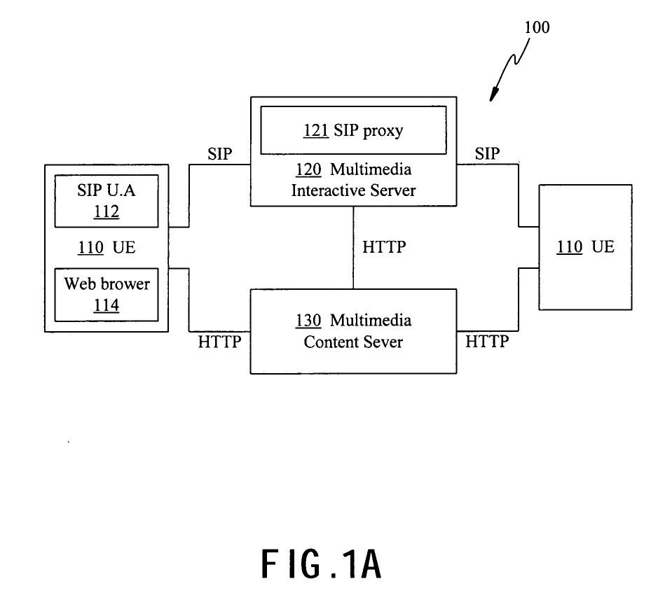

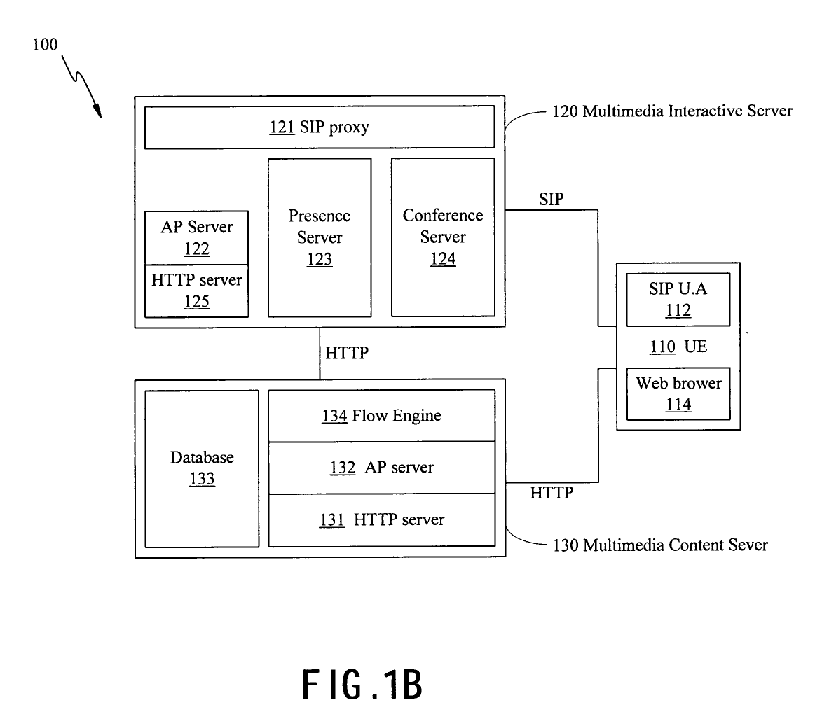

Please refer to FIG. 1A, which is a block diagram of a multimedia interactive system 100 depicts an embodiment in accordance with the present invention. A plurality of multimedia interactive clients 110 are connected to at least one multimedia interactive server 120, at least one multimedia content server 130, and each other via an IP network 101 of the system 100. Each of the plurality of multimedia interactive clients 110 comprises a SIP user agent 112 and a web browser 114. In this regards, a SIP proxy server 121 of the interactive server 120 is configured to perform defined SIP functionalities for the plurality of clients 110 or the plurality of SIP user agents 112 more specified. In another perspective, the content server 130 provides static and dynamic contents for web browsers of the plurality of the clients 110. The static and dynamic contents could be organized into many formats such as defined in the MIME (Multiple-purpose Internet Mail Extensions) and/or HTTP standards. In additional to those standards, the contents could also be organized in proprietary formats such as popular Flash™ and/or FlashLite™ of Macromedia™. The proprietary formatted content could be displayed, showed, played, and/or handled by corresponding proprietary plug-in software components of the web browser 114.

As shown in the FIG. 1A, there exist interactions between the interactive server 120 and the content server 130. Please refer to FIG. 1B, which is a detailed diagram shows a multimedia interactive system 100 of another embodiment in accordance with the present invention. In this regards, the interactive server 120 can further comprise an application server 122, a presence server 123, and a conference server 124. In an example, the application server 122 is built upon or incorporating a HTTP server 125. Therefore, the application server 122 could interact with outside systems such as the content server 130 following HTTP. The presence server 123 is configured to provide information of SIP user presences for the SIP proxy server 121 and the application server 122. The user presence information may comprise buddy list, service list, personal data, and/or any other personal customized information of user. Besides, the conference server 124 is configured to provide uni-cast, multi-cast, and/or other conference services of SIP communication for the SIP proxy server 121.

Business intelligence of the system 100 could be implemented on the application server 122. For example, server-side script could be run on the application server 122. The server-side computation may access the information from the SIP proxy server 121, the presence server 123, and/or the conference server 124 in order to generate response requested by the outside systems.

As shown in the FIG. 1B, the content server 130 may comprises a HTTP server 131 for providing static contents to web browsers 114 of the plurality of clients 110. The provided static content may comprises proprietary formatted data such as interactive Flash/FlashLite™ clips. In addition, an application server 132 and a database server 133 may be provided upon the HTTP server 131 for generating dynamic contents. The server-side computation of the content server 130 may access the data persisted in the database server 133 in order to generate dynamic content according to the persisted data. Moreover, a flow engine 134 could be provided on top of the application server 132 and/or the database server 133 for executing short term flows and/or long-term flows. The flow engine 134 could execute flow templates according to dynamic parameters from the HTTP request and the persisted information. The flow templates could be defined by several standards, such as VoiceXML flow.

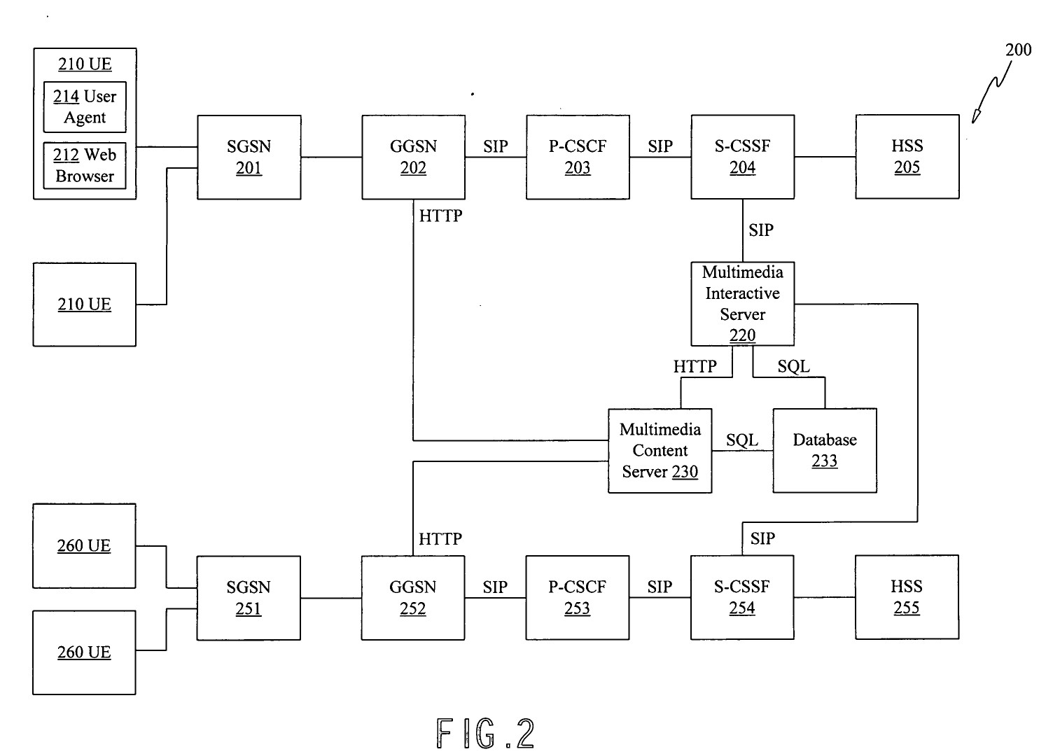

Please refer to FIG. 2, which is a detailed diagram shows a multimedia interactive system 200 of an embodiment in accordance with the present invention. The multimedia interactive system 200 is built on top of IP network provided by GPRS environment. A plurality of user equipments 210, which are GPRS enabled, are attached to the GPRS system 200. Once attached, the IP packets emitted and received by the user equipments 210 would be processed by at least one SGSN (Serving GPRS Support Node) 201 and at least one GGSN (Gateway GPRS Support Node) 202. In this regards, each of the plurality of user equipment 210 comprises a SIP user agent 212 and a web browser 214.

As shown in the FIG. 2, since the multimedia interactive system 200 is built on 3G IMS (IP Multimedia System), at least one P-CSCF (Proxy-Call Session Control Function) 203 and a S-CSCF (Serving Call Session Control Function) 204, which provides session control for subscribers accessing service within the IMS core network and has responsibility for interacting with network data base such as a HSS (Home Subscriber Server) 205 and an AAA server. The P-CSCF 203 is the initial interface between the plurality of user equipments 210 and the IMS core network. The S-CSCF 204 is an IMS element that provides the session control service for the plurality of user equipments 210. The S-CSCF 204 enables the network operator to support the services. The functions are includes as following: the management of user equipment registrations, maintaining of the session, interaction with other services, charging, and security. The HSS 205 is the master database for the PLMN (Public Land Mobile Network). It holds variables and identities for the support, establishment and maintenance of calls and sessions made by subscribers. As well as the basic HLR/AuC (Home Location Registrar/Authentication Center) functions, the HSS 205 may be enhanced through the use of additional databases and reference points. This enables the network to offer the subscribers advanced services and features by interfacing with service application servers, such as a multimedia interactive server 220.

In addition, a multimedia content server 230 and a database server 233 are also placed in the core network shown in the FIG. 2. The packets transmitted from the plurality of user equipments 210 would be routed through the SGSN 201 to the GGSN 202. Next, the packets would be advanced routed to the P-CSCF 203 or the multimedia content server 230 according to the top-layer protocol of the packets by the GGSN 202. For example, if the packets transport SIP traffics, they would be routed to the S-CSCF 204. In case the packets transport HTTP or other contents in proprietary formats mentioned above, they would be routed to the content server 230 by the multimedia content server 230. In one example, both the multimedia interactive server 220 and content server 230 could access the database server 233 directly. In another example, the database server 233 is connected to the content server 230 merely. The interactive server 220 could access the database server 233 via the content server 230.

As shown in the FIG. 2, the interactive server 220, content server 230, and the database server 233 in the core network/IMS of one PLMN could be connected to the core network/IMS of another PLMN, which comprises another SGSN 251, GGSN 252, P-CSCF 253, S-CSCF 254, and HSS 255. A plurality of user equipments 260 attached to the other PLMN also could access the multimedia interactive system 200, too. Moreover, the interactive server 220 may be connected to another SIP network.

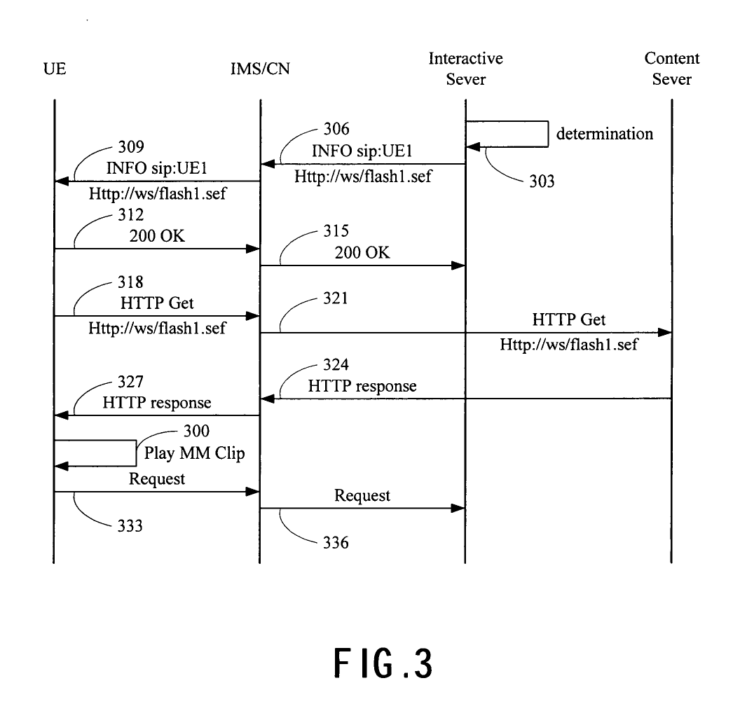

Please refer to FIG. 3, which is a sequence diagram illustrates how the interactive server pushes contents to user equipments. The SGSN, GGSN, P-CSCF, S-CSCF, and HSS could be treated transparently as normal IP network in the FIG. 3. They are denoted as IMS/CN (Core Network) in the FIG. 3. At a startup step 303, the interactive server determined that a multimedia clip should be pushed to at least one attached user equipment. Next, an information command in SIP form transmitted from the interactive server carries an content URL or any useful information for identifying the multimedia clip to IMS/CN at step 306. This command would be sent to the selected user equipment at step 309. Following the SIP conversation, the SIP user agent of the user equipment would return an OK message to the IMS/CN at step 312. This OK message would be forwarded back to the interactive server at step 315. After receiving the content URL or any useful information for identifying the multimedia clip, the web browser and/or proprietary plug-in player of the user equipment would launch a request of the URL to the content server via the IMS/CN at step 318. After receiving the request from the IMS/CN at step 321, the content server responses with the requested multimedia clip at step 324 to the user equipment via the IMS/CN. The multimedia clip would be forwarded by the IMS/CN to the user equipment at step 327.

As shown in the FIG. 3, once the requested multimedia clip is received, the user equipment plays the multimedia clip at step 330. However, if the multimedia clip is interactive, the web browser and/or the plug-in of the user equipment may connect to designated servers for interaction, such as the interactive server and/or the content server. For convenience, the user may direct the interactive multimedia clip to pick up another interactive multimedia clip, stored in the content server, at the play step 330 in this embodiment. Hence, the user equipment issued the request to the interactive server via the IMS/CN at step 333. After receiving the request from the IMS/CN at step 336, the flow repeats itself at the beginning for another cycle.

In this invention, the interactive multimedia clip may be client-server interactive or client-client interactive. For example, a yellow book lookup program is client-server interactive. A chess game or a Ma-jong game program is client-client interactive.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. A multimedia interactive system, comprising:
a plurality of multimedia interactive clients connected to an IP (Internet Protocol) network, wherein each of said multimedia interactive client further comprising a SIP (Session Initiation Protocol) user agent and a web browser;
a multimedia interactive server connected to said IP network, said multimedia interactive server comprising a SIP proxy server for servicing said SIP user agents of said plurality of multimedia interactive clients; and
a multimedia content server connected to said IP network for providing multimedia content, designated in SIP communication by said multimedia interactive server, to said web browsers of said plurality of multimedia interactive clients.

2. A multimedia interactive system of claim 1, wherein said multimedia content server comprising an application server and a database server for persisting said multimedia content, said multimedia interactive server comprising an application server for performing SIP interaction between said plurality of multimedia interactive clients.

3. A multimedia interactive system of claim 2, wherein said multimedia interactive server access said database server via said content server.

4. A multimedia interactive system of claim 1, wherein said multimedia content comprising proprietary Flash and FlashLite formatted content, said web browser also comprising player for proprietary Flash and FlashLite formatted content.

5. A multimedia interactive system of claim 1, wherein said multimedia interactive server further comprising a presence server for providing presence information of said plurality of multimedia interactive clients.

6. A multimedia interactive system of claim 1, wherein said multimedia interactive server further comprising a conference server for providing conference services of SIP communication for said SIP proxy server.

7. A multimedia interactive system of claim 2, wherein said multimedia content server further comprising a flow engine for executing flow templates.

8. A multimedia interactive system of claim 7, wherein VoiceXML flow could be executed by said flow engine.

9. A multimedia interactive system of claim 1, wherein said SIP proxy server is connected outside SIP network other than said IP network.

10. A multimedia interactive system of claim 1, wherein said IP network is built on GPRS (General Packet Radio Service) environment and said plurality of multimedia interactive clients are settled on a plurality of user equipments.

11. A multimedia interactive system of claim 10, wherein said IP network comprises at least one SGSN (Serving GPRS Support Node), one GGSN (Gateway GPRS Support Node), one P-CSCF (Proxy-Call Session Control Function), one S-CSCF (Serving Call Session Control Function), and a HSS (Home Subscriber Server) at a core network defined at 3G and 3G IMS (IP Multimedia System) standards, said multimedia content server is connected to said GGSN, said multimedia interactive server is connected to said S-CSCF.

12. A multimedia interactive method, comprising:
providing a multimedia interactive system, wherein said multimedia interactive system comprising:
a plurality of multimedia interactive clients connected to an IP (Internet Protocol) network, wherein each of said multimedia interactive client further comprising a SIP (Session Initiation Protocol) user agent and a web browser;
a multimedia interactive server connected to said IP network, said multimedia interactive server comprising a SIP proxy server for servicing said SIP user agents of said plurality of multimedia interactive clients; and
a multimedia content server connected to said IP network; and
providing said multimedia designated in SIP communication by said multimedia interactive server to said web browsers of said plurality of multimedia interactive clients.

13. A multimedia interactive method of claim 12, wherein said multimedia content server comprises an application server and a database server for persisting said multimedia content, said multimedia interactive server comprises an application server for performing SIP interaction between said plurality of multimedia interactive clients.

14. A multimedia interactive method of claim 13, wherein said multimedia interactive server access said database server via said content server.

15. A multimedia interactive method of claim 12, wherein said multimedia content comprises proprietary Flash and FlashLite formatted content, said web browser also comprises player for proprietary Flash and FlashLite formatted content.

16. A multimedia interactive method of claim 12, wherein said multimedia interactive server further comprises a presence server for providing presence information of said plurality of multimedia interactive clients.

17. A multimedia interactive method of claim 12, wherein said multimedia interactive server further comprises a conference server for providing conference services of SIP communication for said SIP proxy server.

18. A multimedia interactive method of claim 13, wherein said multimedia content server further comprises a flow engine for executing flow templates.

19. A multimedia interactive method of claim 18, wherein VoiceXML flow could be executed by said flow engine.

20. A multimedia interactive method of claim 13, wherein said SIP proxy server is connected outside SIP network other than said IP network.

21. A multimedia interactive method of claim 12, wherein said IP network is built on GPRS (General Packet Radio Service) environment and said plurality of multimedia interactive clients are settled on a plurality of user equipments.

22. A multimedia interactive method of claim 21, wherein said IP network comprises at least one SGSN (Serving GPRS Support Node), one GGSN (Gateway GPRS Support Node), one P-CSCF (Proxy-Call Session Control Function), one S-CSCF (Serving Call Session Control Function), and a HSS (Home Subscriber Server) at a core network defined at 3G and 3G IMS (IP Multimedia System) standards, said multimedia content server is connected to said GGSN, said multimedia interactive server is connected to said S-CSCF.

23. A multimedia interactive system, comprising:
a plurality of multimedia interactive clients settled on a plurality of user equipments and connected to an IP (Internet Protocol) network based on GPRS (General Packet Radio Service) environment, wherein each of said multimedia interactive client further comprising a SIP (Session Initiation Protocol) user agent and a web browser having player for proprietary Flash and FlashLite formatted content;
a multimedia interactive server connected to said IP network, said multimedia interactive server further comprising:
a SIP proxy server for servicing said SIP user agents of said plurality of multimedia interactive clients;
an application server for performing SIP interaction between said plurality of multimedia interactive clients;
a presence server for providing presence information of said plurality of multimedia interactive clients;
a conference server for providing conference services of SIP communication for said SIP proxy server; and
a flow engine for executing flow templates including VoiceXML flow; and
a multimedia content server connected to said IP network for providing multimedia content, designated in SIP communication by said multimedia interactive server, to said web browsers of said plurality of multimedia interactive clients, wherein said multimedia content server comprising an application server and a database server for persisting said multimedia content including proprietary Flash and FlashLite formatted content.
